(19) United States
(12) Patent Application Publication
(10) Pub. No.: US 2009/0128526 A1
(43) Pub. Date: May 21, 2009

(54) Plasma display device and driving apparatus thereof

(76) Inventors: Myoung-Kyu Lee, Suwon-si (KR); Ki-Ho Shin, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 12/290,039

(22) Filed: Oct. 23, 2008

(30) Foreign Application Priority Data
Nov. 16, 2007 (KR) 10-2007-0117273

(51) Int. Cl. G09G 3/28

(52) U.S. Cl. 345/204; 345/67

(57) ABSTRACT

A driver circuit for a plasma display panel is disclosed. The driver circuit has a switch which is shared between the reset driver portion of the driver circuit and the sustain driver portion of the driver circuit. The driver circuit sharing the switch between the two portions is smaller and cheaper than other driver circuits.

### CROSS-REFERENCE TO RELATED APPLICATION

This application claims priority to and the benefit of Korean Patent Application No. 10-2007-0117273 filed in the Korean Intellectual Property Office on Nov. 16, 2007, the entire contents of which are incorporated herein by reference.

### BACKGROUND

1. Field

The field relates to a plasma display device and a driving apparatus thereof. More particularly, the field relates to a plasma display device and a driving apparatus thereof that enables simplification of a circuit by reducing the number of elements.

2. Description of the Related Technology

A plasma display device is a flat panel display that uses plasma generated by gas discharge to display characters or images. A display panel of the plasma display device includes, depending on its size, more than several scores to millions of discharge cells (hereinafter, simply called cells) arranged in a matrix pattern.

The plasma display device is driven by dividing one frame into a plurality of subfields each subfield having a grayscale weight value. In this case, luminance of a discharge cell for a frame is determined by the sum of the grayscale weight values of subfields for the frame.

In addition, each subfield includes a reset period, an address period, and a sustain period. The reset period is for initializing a wall charge state of each discharge cell, and the address period is for performing an addressing operation so as to select turn-on cells. The sustain period is for displaying an image by sustain-discharging the turn-on cells selected in the address period for a duration that corresponds to the weight value of the corresponding subfield.

In the reset period, the wall charge state is initialized through a weak discharge induced by applying a gradually decreasing voltage waveform to a scan electrode after applying a gradually increasing voltage waveform (hereinafter called a reset rising waveform) to a scan electrode. In the sustain period, the sustain discharge is induced at the turn-on cells by applying a sustain pulse with opposite phases to a scan electrode and a sustain electrode.

In a typical plasma display device, a circuit for applying a reset rising waveform to the scan electrode and a circuit for applying a sustain discharge pulse are separately arranged.

That is, a voltage (hereinafter called a reset rising voltage) necessary for the reset rising waveform and a voltage (hereinafter called a sustain voltage) necessary for the sustain discharge pulse are set to different voltage levels, and a power source for supplying a reset rising voltage and a power source for supplying a sustain voltage are separately arranged. Further, a switch for applying the reset rising voltage to the scan electrode and a switch for applying the sustain voltage to the scan electrode are separately arranged.

According to such a scheme, because the reset rising voltage and the sustain voltage are set to different voltage levels, a separate element should be additionally employed so as to prevent a current path from being formed toward the power source for supplying the reset rising voltage or the power source for supplying the sustain voltage. Accordingly, there is a limitation in simplifying the circuit.

The above information disclosed in this Background section is only for enhancement of understanding of the background of the invention and therefore it may contain information that does not form the prior art that is already known in this country to a person of ordinary skill in the art.

### SUMMARY OF CERTAIN INVENTIVE ASPECTS

One aspect is a plasma display device, which includes a plasma display panel with first, second, and third electrodes, the third electrode extending in a direction that crosses the first and second electrodes, and a discharge cell near the crossing of the third electrode and the first and second electrodes. The device also includes a driver that drives the first electrode, where the driver includes a switch connected between the first electrode and a first power source that supplies a first voltage, a first switch driver that gradually increases a voltage of the first electrode from a second voltage to a third voltage by turning on the switch, where the third voltage is higher than the second voltage, and a second switch driver that supplies the first voltage to the first electrode by turning on the switch.

Another aspect is a driving apparatus of a plasma display device having a plurality of electrodes. The driving apparatus has a first switch that is connected between a node electrically connected with the plurality of electrodes and a first power source configured to supply a first voltage, a first switch driver that, during a rising period of a reset period, gradually increases a voltage of the plurality of electrodes from a second voltage to a third voltage by turning on the first switch, where the third voltage is higher than the second voltage, and a second switch driver that supplies the first voltage to the plurality of electrodes by turning on the first switch in a sustain period.

Another aspect is a plasma display panel device, including a plurality of electrodes, and a driver circuit configured to drive the electrodes, where the driver includes a reset driver portion, configured to drive the electrodes during a reset period, and a sustain driver portion, configured to drive the electrodes during a sustain period. The driver circuit includes a switch which is part of both the reset driver portion and the sustain driver portion, and the switch is turned on by the reset driver portion to drive the electrodes during the reset period and is turned on by the sustain driver portion to drive the electrodes during the sustain period.

### BRIEF DESCRIPTION OF THE DRAWINGS

FIG. 1 is a block diagram of a plasma display device according to an exemplary embodiment.

FIG. 2 shows a driving waveform of a plasma display device according to an exemplary embodiment.

FIG. 3 shows a scan electrode driver 400 according to an exemplary embodiment.

FIG. 4 shows first and second current paths \textcircled{1} and \textcircled{2} realizing the driving waveform for the scan electrode Y during the rising period of the reset period of the driving waveform of FIG. 2, with use of the scan electrode driver 400 according to an exemplary embodiment.

FIG. 5 shows a third current path \textcircled{3} realizing a Vs voltage period of the driving waveform for the scan electrode Y in the sustain period of the driving waveform of FIG. 2, with use of the scan electrode driver 400 according to an exemplary embodiment.

### DETAILED DESCRIPTION OF CERTAIN INVENTIVE EMBODIMENTS

In the following detailed description, only certain exemplary embodiments have been shown and described, simply by way of illustration. As those skilled in the art would realize, the described embodiments may be modified in various ways, without departing from the spirit or scope of the present invention. Accordingly, the drawings and description are to be regarded as illustrative in nature and not restrictive. Like reference numerals generally designate like elements throughout the specification.

Throughout this specification and the claims that follow, when it is described that an element is “coupled” to another element, the element may be directly coupled to the other element or indirectly coupled to the other element through a third element.

The wall charges described in the present specification are charges formed on a wall (e.g., a dielectric layer) close to each electrode of a discharge cell. The wall charges will be described as being “formed” or “accumulated” on the electrode, although the wall charges may not actually touch the electrodes. A wall voltage is a potential difference formed on the wall of the discharge cell by the wall charges.

When it is described in the specification that a voltage is maintained, it should not be understood to strictly imply that the voltage is maintained precisely at a voltage value. To the contrary, even if a voltage difference between two points varies, the voltage difference is expressed to be maintained at a voltage value if the variance is within a range allowed in design constraints or in the case that the variance is caused due to a parasitic component that is usually disregarded by a person of ordinary skill in the art. In addition, since threshold voltages of semiconductor elements (e.g., a transistor and a diode) are very low compared to a discharge voltage, they are generally considered to be 0V.

Now, a plasma display device and a driving apparatus thereof according to an exemplary embodiment will be described in detail with reference to the drawings.

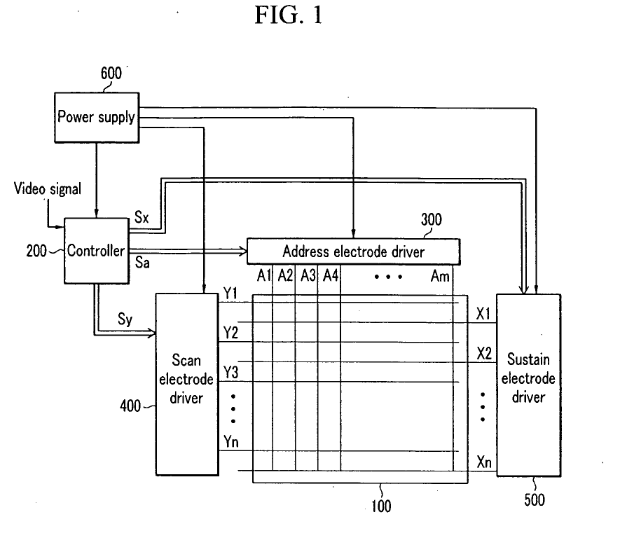

FIG. 1 is a block diagram of a plasma display device according to an exemplary embodiment.

As shown in FIG. 1, a plasma display device includes a plasma display panel (PDP) 100, a controller 200, an address electrode driver 300, a scan electrode driver 400, a sustain electrode driver 500, and a power supply 600.

The PDP 100 includes a plurality of address electrodes A1-Am extending in a column direction and a plurality of sustain and scan electrodes X1-Xn and Y1-Yn extending in a row direction by pairs. The sustain electrodes X1-Xn are formed correspondingly to the scan electrodes Y1-Yn. The PDP 100 includes a substrate (not shown) where the sustain electrodes X1-Xn and the scan electrodes Y1-Yn are arranged and another substrate (not shown) where the address electrodes A1-Am are arranged. The two substrates are placed facing each other with a discharge space therebetween so that the scan electrodes Y1-Yn and the address electrodes A1-Am may perpendicularly cross each other and the sustain electrodes X1-Xn and the address electrodes A1-Am may perpendicularly cross each other. The discharge spaces formed near crossing regions of the address electrodes A1-Am and the sustain and scan electrodes X1-Xn and Y1-Yn form discharge cells. This is an exemplary structure of the PDP 100, and panels of other structures can be applied to the present invention.

The controller 200 receives video signals and outputs an address electrode driving control signal Sa, a sustain electrode driving control signal Sx, and a scan electrode driving control signal Sy. In addition, the controller 200 divides one frame into a plurality of subfields and drives the subfields, where each subfield includes a reset period, an address period, and a sustain period.

The address electrode driver 300 receives the address electrode driving control signal Sa from the controller 200 and applies a display data signal to each address electrode so as to select turn-off cells and turn-on cells.

The scan electrode driver 400 receives the scan electrode driving control signal Sy from the controller 200 and applies a driving voltage to a scan electrode Y.

The sustain electrode driver 500 receives the sustain electrode driving control signal Sx from the controller 200 and applies a driving voltage to a sustain electrode X.

The power supply 600 supplies power for driving the plasma display device to the controller 200 and the respective drivers 300, 400, and 500.

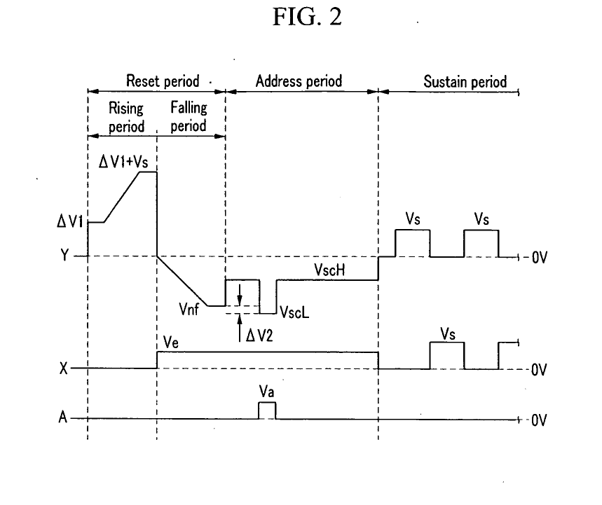

Hereinafter, a driving waveform of a plasma display device according to an exemplary embodiment is described in detail with reference FIG. 2.

FIG. 2 shows a driving waveform of a plasma display device according to an exemplary embodiment.

For convenience of description and better understanding, FIG. 2 only shows a single subfield among a plurality of subfields, and the following description is focused on a driving waveform applied to the scan electrode Y, the sustain electrode X, and the address electrode A of a single cell.

The reset period will now be described. The reset period includes a rising period and a falling period. During the rising period, a voltage of the scan electrode Y is gradually increased from a voltage ΔV to a voltage (ΔV+Vs) while the address electrode A and the sustain electrode X are maintained at a reference voltage (e.g., 0V in FIG. 2, and hereinafter the exemplary reference voltage is 0V). In this case, a weak discharge is generated between the scan electrode and the sustain electrode X and between the scan electrode Y and the address electrode A so that negative (−) wall charges are formed on the scan electrode Y and positive (+) wall charges are formed on the sustain electrode X and the address electrode A. Since all cells need to be reset during the reset period, the voltage (ΔV+Vs) is set to a voltage that is high enough to cause a discharge in all the cells, regardless of their current state.

During the falling period, the voltage of the scan electrode Y is gradually decreased from the reference voltage to a voltage Vnf while the address electrode A and the sustain electrode X are maintained at the reference voltage and a voltage Ve. In this case, a weak discharge is generated between the scan electrode Y and the sustain electrode X and between the scan electrode Y and the address electrode A so that the negative (−) wall charges formed on the scan electrode Y and the positive (+) wall charges formed on the sustain electrode X and the address electrode A during the rising period are erased. In general, a voltage (Vnf-Ve) is set close to a discharge firing Vf voltage between the scan electrode Y and the sustain electrode X, and accordingly, a wall voltage difference between the scan electrode Y and the sustain electrode X becomes close to 0V so that a cell that has not experienced an address discharge during the address period can be prevented from experiencing a misfiring.

During the address period, a scan pulse having the voltage VscL (i.e., the scan voltage) is sequentially applied to the plurality of scan electrodes Y1-Yn while the sustain electrode X is applied with the voltage Ve so as to select light emitting cells. Simultaneously, an address voltage is applied to an address electrode A that passes a light emitting cell among a plurality of cells formed by the scan electrode Y to which the voltage VscL is applied. Then, an address discharge is generated between the address electrode A to which the address voltage Va is applied and the scan electrode Y to which the voltage VscL is applied and between the scan electrode Y to which the voltage VscL is applied and a sustain electrode X that corresponds to the scan electrode Y to which the voltage VscL is applied. Accordingly, positive (+) wall charges are formed on the scan electrode Y and negative (−) wall charges are formed on the address electrode A and the sustain electrode X, respectively. In this case, the voltage VscL is set to be equal to the voltage Vnf or lower than that by a predetermined voltage ΔV2. Meanwhile, a scan electrode Y to which the voltage VscL is not applied is applied with a voltage VscH (i.e., a non-scan voltage) that is higher than the voltage VscL, and an address electrode A of an unselected discharge cell is applied with the reference voltage.

During the sustain period, a sustain pulse having a high level voltage (Vs in FIG. 2) and a low level voltage (0V in FIG. 2) is alternately applied in opposite phases to the scan electrode Y and the sustain electrode X. Thus, 0V is applied to the sustain electrode X when the voltage Vs is applied to the scan electrode Y and 0V is applied to the scan electrode Y when the voltage Vs is applied to the sustain electrode X, and a discharge is generated in the scan electrode Y and the sustain electrode X by a wall voltage formed between the scan electrode Y and the sustain electrode X due to the address discharge and the voltage Vs. Then, an operation for applying the sustain pulse to the scan electrode Y and the sustain electrode X is repeated a number of times corresponding to a weight of the data of the corresponding subfield.

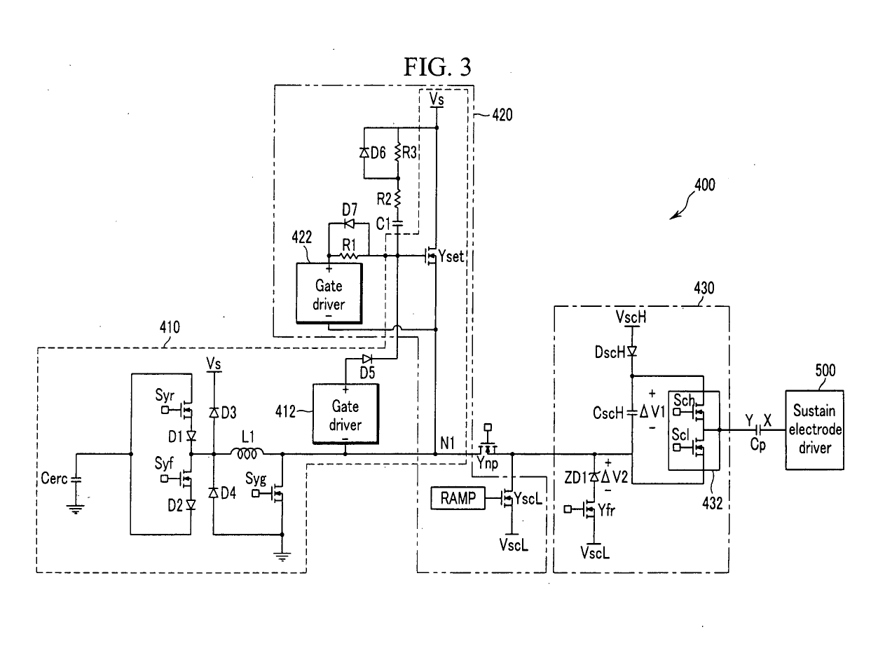

Hereinafter, the scan electrode driver 400 according to an exemplary embodiment will be described in further detail with reference to FIG. 3. The scan electrode driver 400 includes a plurality of driving circuits for realizing the driving waveform of FIG. 2, and only a portion of the circuitry for generating the driving waveform of the reset period illustrated in FIG. 3. In addition, although the switch is illustrated as an N-channel field effect transistor (FET) having a body diode (not shown) in FIG. 3, another switch that performs a function that is similar to or the same as that of the FET can also be used as the transistor. Further, a capacitive component formed by the sustain electrode X and the scan electrode Y is illustrated as a panel capacitor Cp.

FIG. 3 shows a scan electrode driver 400 according to an exemplary embodiment.

As shown in FIG. 3, the scan electrode driver 400 includes a sustain driver 410, a reset driver 420, a scan driver 430, and a path switch Ynp.

The scan driver 430 includes a switch Yfr, a zener diode ZD1, a capacitor CscH, a diode DscH, and a scan circuit 432.

An anode of the diode DscH is connected with a power source VscH supplying a voltage VscH, and a cathode thereof is connected with a first end of the capacitor CscH. A source of the switch Yfr is connected with a power source VscL that supplies a voltage VscL. An anode of the zener diode ZD1 is connected with a drain of the switch Yfr, and a cathode thereof is connected with a second end of the capacitor CscH and also connected with a switch YscL.

The capacitor CscH is charged to the voltage ΔV≡1 shown in FIG. 2 (i.e., a voltage difference of VscH and VscL) during the rising period of the reset period. That is, when the switch YscL turned on, the capacitor CscH is charged to a voltage of VscH-VscL, i.e., the voltage ΔV1.

In addition, a voltage difference between the anode and the cathode of the zener diode ZD1 in the falling period of the reset period is the voltage ΔV2 shown in FIG. 2, i.e., a voltage difference of VscL and Vnf.

The scan circuit 432 includes a switch Sch and a switch Sc1.

A drain of the switch Sch is connected with a node of the diode DscH and the capacitor CscH, and a source thereof is connected with the scan electrode Y. A drain of the transistor Sc1 is connected with the scan electrode Y, and a source thereof is connected with a node of the capacitor CscH and the zener diode ZD1.

In the address period, the scan circuit 432 applies the voltage VscL to the scan electrode Y for selecting a turn-on cell, and applies the voltage VscH to the scan electrode Y of a turn-off cell. In some embodiments, the scan circuit 432 is connected to each of the plurality of scan electrodes Y1-Yn in an IC form, and sequentially selects the plurality of scan electrodes Y1-Yn in the address period. A driving circuit of the scan electrode driver 400 is connected to the plurality of scan electrodes Y1-Yn through scan circuit 432. In FIG. 3, one scan electrode Y and one scan circuit 432 corresponding to one scan electrode Y are illustrated.

The path switch Ynp is coupled between a node N1 and the source of the switch Scl. The path switch Ynp remains on during the sustain period and the rising period of the reset period, and thereby, the voltage of the node N1 is supplied to the scan electrode Y through the path switch Ynp.

The sustain driver 410 includes a capacitor Cerc, switches Syr, Syf, Syg, and Yset, diodes D1, D2, D3; D4, and D5, an inductor L1, and a gate driver 412.

A drain of the switch Yset is connected with a power source Vs that supplies the voltage Vs, and a source thereof is connected with the node N1. A reference voltage input terminal (−) of the gate driver 412 is connected with a source of the switch Yset. A cathode of the diode D5 is connected with a control terminal of the switch Yset, and an anode thereof is connected with an output terminal (+) of the gate driver 412. A drain of the switch Syg is connected with the node N1, and a source thereof is grounded. An anode of the diode D4 is connected with the ground. An end of the inductor L1 is connected with the node N1, and another end thereof is connected with a cathode of the diode D4. An anode of the diode D3 is connected with a node of the inductor L1 and the diode D4, and a cathode thereof is connected with the power source Vs. A drain of the switch Syf is connected with the node of the inductor L1 and the diode D4, and a cathode of the diode D1 is connected with the drain of the switch Syf. An anode of the diode D2 is connected with a source of the switch Syf, and a source of the switch Syr is connected with an anode of the diode D1. In addition, a first end of the capacitor Cerc is connected with a drain of the switch Syr and a cathode of the diode D2, and a second end thereof is grounded.

The reset driver 420 includes the switches Yset, and YscL, resisters R1, R2, and R3, diodes D6 and D7, a capacitor C1, and a gate driver 422.

The source of the switch Yset is connected with the node N1, and the drain thereof is connected with the power source Vs as described above. A first end of the resistor R3 is connected with the power source Vs, and a first end of the resistor R2 is connected with a second end of the resistor R3. An anode of the diode D6 is connected with a node of the resistors R2 and R3, and a cathode thereof is connected with the first end of the resistor R3. A first end of the capacitor C1 is connected with a second end of the resistor R2, and a second end thereof is connected with the control electrode of the switch Yset. A first end of the resistor R1 is connected with the control electrode of the switch Yset, and a second end thereof is connected with an output terminal (+) of the gate driver 422. An anode of the diode D7 is connected with the first end of the resistor R1, and a cathode thereof is connected with the second end of the resistor R1. A reference voltage input terminal (−) of the gate driver 422 is connected with the source of the switch Yset. In addition, a drain of the switch YscL is connected with a node of the path switch Ynp and the switch Scl, and a source thereof is connected with the power source VscL.

In the scan electrode driver 400, a single switch Yset is used by both the sustain driver 410 and the reset driver 420. During the reset period, the reset driver 420 uses the switch Yset to increase the voltage of the scan electrode Y from the voltage ΔV1 to the voltage ΔV1+Vs. During the sustain period, the sustain driver 410 uses the switch Yset to maintain the voltage of the scan electrode at the voltage Vs. Therefore, in comparison with a conventional plasma display device that employs separate switches in the sustain driver and the reset driver, production costs may be decreased by reducing the number of elements and a circuit design may become easier.

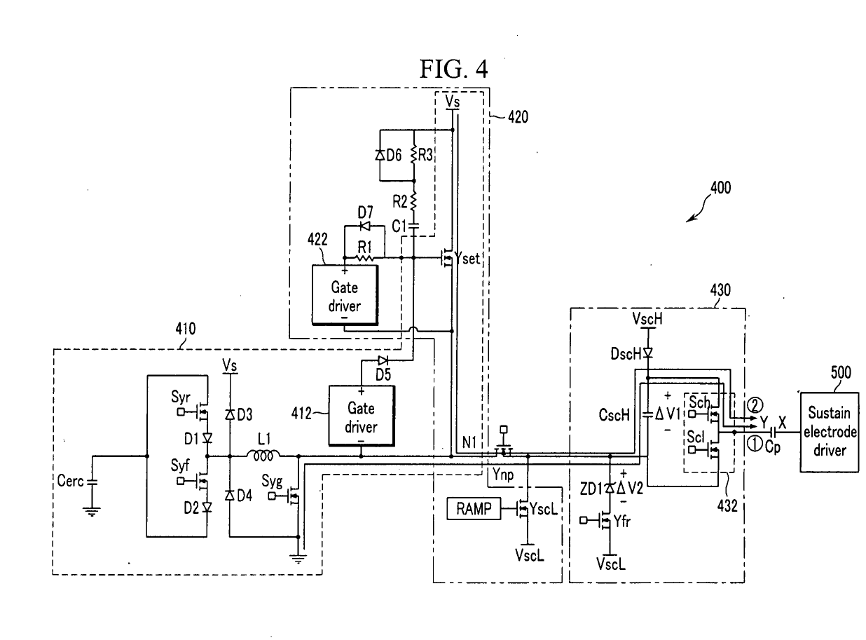

Hereinafter, current paths realizing the driving waveform for the scan electrode Y in the rising period of the reset period using the scan electrode driver 400 are described with reference to FIG. 4.

FIG. 4 shows first and second current paths \textcircled{1} and \textcircled{2}.

During the rising period of the reset period, the switches Syg, Sch, and Ynp are on in order to increase the voltage of the scan electrode Y from the reference voltage to ΔV1.

Since the switches Syg and Sch are on, a current may flow through a first current path \textcircled{1} formed from the ground terminal to the scan electrode passing through the switches Syg and Ynp, the capacitor CscH, and the switch Sch. Then, the charged voltage of the capacitor CscH (i.e., the voltage ΔV1 that is a voltage difference of VscH and VscL) is applied to the scan electrode Y and thus, the voltage of the scan electrode Y increases from the reference voltage to ΔV 1.

While the voltage of the scan electrode increase from the reference voltage to ΔV1 by the current flowing through the first current path \textcircled{1}, the gate driver 422 outputs a low level signal so that the switch Yset remains off. In addition, a current path is formed from the power source Vs to the source of the switch Yset passing through the resistor R3, the resistor R2, the capacitor C1, the diode D7, and the gate driver 422, and accordingly, the capacitor C1 is charged with a predetermined voltage.

After the voltage of the scan electrode Y reaches the voltage ΔV1, the switch Syg is turned off, and the switch Yset is turned on. Here, the turning on of the switch Yset is controlled by the gate driver 422. By such an operation, a current flows through a second current path \textcircled{2} formed from the power source Vs to the scan electrode Y passing through the switch Yset, the switch Ynp, the capacitor CscH, and the switch Sch. In this case, the voltage of the scan electrode Y increases from ΔV1 to ΔV1+Vs in a ramp pattern.

An increase of the voltage of the scan electrode Y from ΔV1 to ΔV1+Vs in a ramp pattern is hereinafter described in detail.

When the gate driver 422 supplies a high level signal to the control electrode of the switch Yset in order to turn on the switch Yset, a resonance waveform of the resistor R1 and the capacitors of the capacitor C1 and parasitic capacitance components between the gate and the drain and between the gate and source of the switch Yset occurs. Accordingly, the voltage of the control electrode of the switch Yset increases higher than a threshold voltage of the switch Yset, and then the switch Yset is turned on. When the switch Yset is turned on, a current flows through the second current path \textcircled{2}. As a result, the voltage of the scan electrode Y increases because the source voltage of the switch Yset increases. In this case, the voltage of the control electrode of the switch Yset decreases below the threshold voltage of the switch Yset due to the capacitor C1 and the parasitic capacitance component between the gate and the drain of the switch Yset. Therefore, the switch Yset is turned off although the gate driver 422 maintains supplying of the high level signal to the control electrode of the switch Yset. When the switch Yset is turned off, a current flows through the path from the power source Vs to the capacitor C1 passing through the resistor R3 and the resistor R2, and thereby the capacitor C1 is charged with a voltage. Since the gate driver 422 maintains the supplying of the high level signal to the control electrode of the switch Yset, the voltage of the control electrode of the switch Yset increases above the threshold voltage of the switch Yset. Therefore, the switch Yset is turned on again, and a current flows through the second current path \textcircled{2} again.

The turning on and off of the switch Yset is repeated until the source voltage of the switch Yset reaches the voltage Vs, and thereby, the voltage of the scan electrode Y is gradually increased from ΔV1 to ΔV1+Vs in a ramp pattern.

In order to slowly charge and rapidly discharge the capacitor C1, the resistance of the resistor R3 is set very high in comparison with the resistance of the resistor R2.

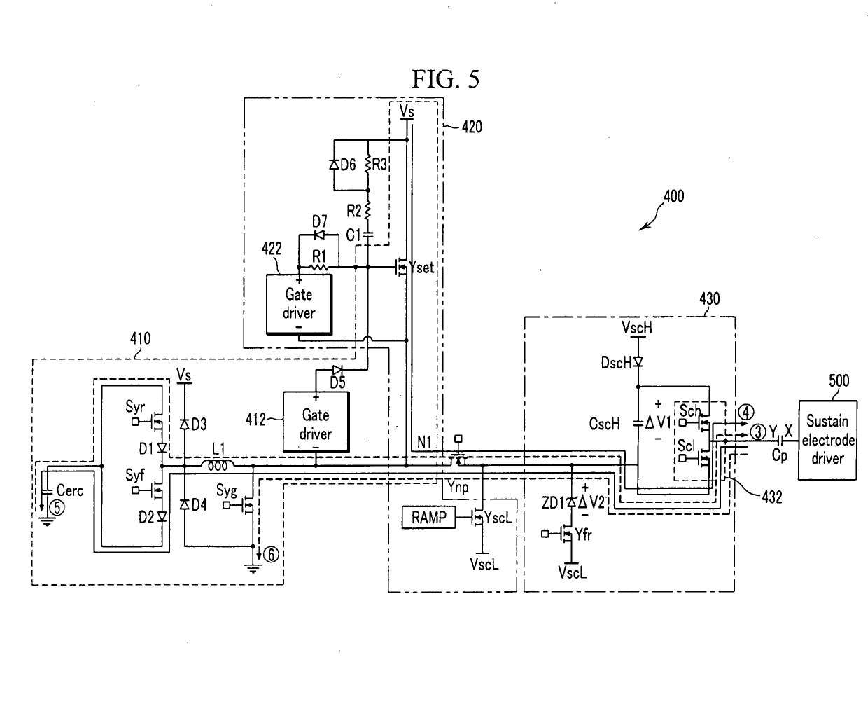

Hereinafter, current paths realizing the driving waveform for the scan electrode Y in the sustain period using the scan electrode driver 400 is described in detail with reference to FIG. 5.

FIG. 5 shows a third to sixth current paths \textcircled{3} to \textcircled{6}. In FIG. 5, the third current path \textcircled{1} and the sixth current path \textcircled{6} are shown in dotted lines, and the fourth current path \textcircled{4} and the fifth current path \textcircled{5} are shown in solid lines.

When the switches Syr, Ynp, and Scl are turned on, the third current path \textcircled{3} is formed from the ground terminal to the scan electrode Y passing through the capacitor Cerc, the switch Syr, the diode D1, the inductor L1, the switch Ynp, and the switch Scl. When the current flows through the third current path \textcircled{3}, a resonance occurs between the inductor L1 and the panel capacitor Cp, and thereby, the voltage of the scan electrode Y increases from the reference voltage to the voltage Vs.

When the switches Yset, Ynp, and Scl are turned on, the fourth current path \textcircled{4} is formed through the power source Vs to the scan electrode Y passing through the switch Yset, the switch Ynp, and the switch Scl. When the current flows through the fourth current path \textcircled{4}, the voltage of the scan electrode Y remains at the voltage Vs.

In this case, the turning on of the switch Yset is enabled by simultaneously supplying the high level signal to the control electrode of the switch Yset by the gate driver 412 and the gate driver 422. Here, the high level signal is also supplied to the control electrode of the switch Yset from gate driver 422 in order to prevent the signal applied to the control electrode of the switch Yset from being inputted through a terminal (+) of the gate driver 422 and then outputted to the source of the switch Yset through another terminal (−), which may occur when the high level signal is only supplied to the control electrode of the switch Yset by the gate driver 412.

When the switches Scl, Ynp, and Syf are turned on, the fifth current path \textcircled{5} is formed from the scan electrode Y to the ground terminal passing through the switches Scl and Ynp, the inductor L1, the switch Syf, the diode D2, and the capacitor Cerc. When the current flows through the fifth current path \textcircled{5}, a resonance occurs between the inductor L1 and the panel capacitor Cp, and thereby, the voltage of the scan electrode Y decreases from the voltage Vs to the reference voltage.

When the switches Scl, Ynp, and Syg are turned on, the sixth current path \textcircled{6} is formed from the scan electrode Y to the ground terminal passing through the switch Scl, the switch Ynp, and the switch Syg. When the current flows through the sixth current path \textcircled{6}, the voltage of the scan electrode Y remains at the reference voltage, ground.

According to the scan electrode driver 400, a voltage is applied to the scan electrode in the reset period and the sustain period by using a single switch Yset. Therefore, a production cost may be decreased by reducing the number of elements and a circuit design may become easier.

While this invention has been described in connection with what is presently considered to be practical exemplary embodiments, it is to be understood that the invention is not limited to the disclosed embodiments, but, on the contrary, is intended to cover various modifications and equivalent arrangements.

What is claimed is:

1. A plasma display device, comprising:
a plasma display panel including first, second, and third electrodes, the third electrode extending in a direction that crosses the first and second electrodes, and a discharge cell near the crossing of the third electrode and the first and second electrodes; and
a driver that drives the first electrode,
wherein the driver comprises:
a switch connected between the first electrode and a first power source that supplies a first voltage;
a first switch driver that gradually increases a voltage of the first electrode from a second voltage to a third voltage by turning on the switch, wherein the third voltage is higher than the second voltage; and
a second switch driver that supplies the first voltage to the first electrode by turning on the switch.

2. The plasma display device of claim 1, further comprising a controller that drives the plasma display panel by dividing a frame into a plurality of subfields, wherein:
at least one subfield among the plurality of subfields comprises a reset period for initializing the discharge cell, an address period for selecting the discharge cell as a turn-on cell or a turn-off cell, and a sustain period for sustain-discharging the turn-on cells;
the first switch driver turns on the switch during a portion of the reset period; and
the second switch driver turns on the switch during a portion of the sustain period.

3. The plasma display device of claim 1, wherein the third voltage equals a sum of the first voltage and the second voltage.

4. The plasma display device of claim 1, wherein the first switch driver comprises:
a capacitor connected between the first power source and a control electrode of the switch;
a first gate driver of which a reference voltage input terminal is connected with a first terminal of the switch; and
a first resistor connected between an output terminal of the first gate driver and the control electrode of the switch.

5. The plasma display device of claim 4, wherein the first switch driver further comprises:
a second resistor and a third resistor that are coupled in series between the first power source and the control electrode of the switch; and
a diode that is coupled in parallel with the second resistor so as to form a current path from the capacitor to the power source.

6. The plasma display device of claim 5, wherein the second resistor has a higher resistance than the third resistor.

7. The plasma display device of claim 4, wherein the second switch driver comprises:
a diode of which a cathode is connected with the control electrode of the switch; and
a second gate driver of which an output terminal is connected with an anode of the diode and of which a reference voltage input terminal is connected with a terminal of the switch.

8. A driving apparatus of a plasma display device having a plurality of electrodes, comprising:
a first switch that is connected between a node electrically connected with the plurality of electrodes and a first power source configured to supply a first voltage;
a first switch driver that, during a rising period of a reset period, gradually increases a voltage of the plurality of electrodes from a second voltage to a third voltage by turning on the first switch, wherein the third voltage is higher than the second voltage; and
a second switch driver that supplies the first voltage to the plurality of electrodes by turning on the first switch in a sustain period.

9. The driving apparatus of claim 8, wherein the first switch driver comprises:
a capacitor connected between the first power source and a control electrode of the first switch;
a first gate driver of which a reference voltage input terminal is connected with a first terminal of the first switch; and
a first resistor connected between an output terminal of the first gate driver and the control electrode of the first switch.

10. The driving apparatus of claim 9, wherein the first switch driver further comprises:
a second resistor and a third resistor that are coupled in series between the first power source and the control electrode of the first switch; and
a diode that is coupled in parallel with the second resistor so as to form a current path from the capacitor to the power source.

11. The driving apparatus of claim 10, wherein the second resistor has a higher resistance than the third resistor.

12. The driving apparatus of claim 9, wherein the second switch driver comprises:
a diode of which a cathode is connected with the control electrode of the first switch; and
a second gate driver of which an output terminal is connected with an anode of the diode and of which a reference voltage input terminal is connected with a terminal of the first switch.

13. The driving apparatus of claim 8, wherein the third voltage is higher than the first voltage by the second voltage.

14. The driving apparatus of claim 13, further comprising a scan driver that sequentially applies a scan voltage to some of the plurality of electrodes and applies a non-scan voltage to others of the plurality of electrodes during an address period,
wherein the second voltage corresponds to a voltage difference between the non-scan voltage and the scan voltage.

15. The driving apparatus of claim 14, further comprising a second switch that is connected between the node and a second power source supplying a fourth voltage and supplies the fourth voltage to the plurality of electrodes by being turned on in a sustain period,
wherein the plurality of electrodes alternately receive the first and fourth voltages in the sustain period, and wherein the fourth voltage is lower than the first voltage.

16. A plasma display panel device, comprising:
a plurality of electrodes; and
a driver circuit configured to drive the electrodes, wherein the driver comprises:
a reset driver portion, configured to drive the electrodes during a reset period; and
a sustain driver portion, configured to drive the electrodes during a sustain period,
wherein the driver circuit comprises a switch which is a part of both the reset driver portion and the sustain driver portion, and wherein the switch is turned on by the reset driver portion to drive the electrodes during the reset period and is turned on by the sustain driver portion to drive the electrodes during the sustain period.

17. The device of claim 16, wherein the switch is configured to connect the electrodes to a power supply voltage during the sustain period.

18. The device of claim 16, further comprising a capacitor, configured to store a reference voltage, wherein the switch is configured to connect the capacitor to a power supply voltage during the reset period.

19. The device of claim 18, wherein the capacitor is configured to store a reference voltage and to apply to the electrodes a voltage substantially equal to the power supply voltage plus the reference voltage.

20. The device of claim 18, wherein the driver circuit further comprises an address driver portion, and the address driver portion is configured to drive the electrodes with either of first and second address voltages, wherein the reference voltage is substantially equal to the difference between the first and second address voltages.
